(19) United States
(12) Patent Application Publication
(10) Pub. No.: US 2009/0060193 A1
(43) Pub. Date: Mar. 5, 2009

(54) DEVICE FOR ENCRYPTED COMMUNICATION

(75) Inventors: Georg Jahnen, Unterschleissheim (DE); Jens Rehwagen, Wolfratshausen (DE); Anton Enterrottacher, Erding (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Rohde & Schwarz SIT GmbH, Berlin (DE)

(21) Appl. No.: 11/955,109

(22) Filed: Dec. 12, 2007

(30) Foreign Application Priority Data
Sep. 5, 2007 (DE) 20 2007 012 486.4

(51) Int. Cl. H04L 9/00

(52) U.S. Cl. 380/275

(57) ABSTRACT

A communication device for encrypted transmission of information via unencrypted transmission paths has at least one loudspeaker, one microphone, one audio processing facility, one encryption facility, and one transmission facility. Information is encrypted by the encryption facility and transmitted via unencrypted transmission paths by the transmission facility by further communication instruments. Thus, flexible use on the basis of the various communication instruments which can be used for encrypted transmission is made possible.

### BACKGROUND OF THE INVENTION

1. Field of the Invention

The invention concerns a device for encrypted transmission of information via unencrypted transmission paths, in particular mobile telephone connections and fixed network connections.

2. Related Technology

Traditionally, special, encrypting communication terminals are required by all participating communication subscribers for encrypted transmission of communication connections. The encryption mechanism is integrated into the relevant terminal. Thus for different applications such as telephoning, data transmission and sending faxes, the user requires different encrypting terminals. For communication with non-encrypting subscribers, the subscriber requires further, non-encrypting terminals. The user thus requires numerous different terminals to be able to cover all communication needs.

Thus in EP 0 915 590 B1, a method and a device which make encrypted communication by a network with a mobile telephone possible are shown. The mobile telephone must fulfill special conditions. It is thus necessary that the mobile telephone can autonomously execute encryption and decryption algorithms. This sets high requirements for the terminal limits the flexibility of use.

### SUMMARY OF THE INVENTION

The invention provides an instrument which makes it possible to reduce the number of terminals which are required for encrypted and unencrypted communication, and simultaneously to make convenient, ergonomic use possible.

Accordingly, the invention provides a communication device for encrypted transmission of information via unencrypted transmission paths.

The inventive communication device for encrypted transmission of information via unencrypted transmission paths has at least one loudspeaker, one microphone, one audio processing facility, one encryption facility, and one transmission facility. Information is encrypted by the encryption facility and transmitted via unencrypted transmission paths by the transmission facility by further communication instruments. Thus flexible use on the basis of the various communication instruments which can be used for encrypted transmission is made possible.

Advantageously, the information preferably comprises audio calls and/or data calls. Thus the use of different encrypting communication instruments is no longer necessary. The communication device can process information from different sources and transmit it encrypted.

In one form, the communication device set up audio calls to a user, preferably by means of the loudspeaker and microphone. Thus, in the case of the audio call, no further terminal is required as the data source and/or data sink.

In one form, the communication device set up data calls, preferably by a multi-function interface to a data source and/or data sink. Preferably, the data source and/or data sink is a computer or a mobile telephone. By the use of a multi-function interface, many different terminals can be connected to a single interface as data sources and/or sinks.

The data call between the multi-function interface and the data source and/or data sink is preferably not encrypted. Preferably, the encryption facility encrypts and/or decrypts the information which is received and to be sent via the multi-function interface. The transmission facility advantageously transmits the encrypted information. Secure transmission of the originally unencrypted information is thus ensured. Also, no special encrypting terminals are required as the data source and/or data sink.

The multi-function interface is preferably in such a form that a microphone and/or headphones can be connected, and that when a microphone and/or headphones are connected, the microphone which forms part of the communication device, and/or the loudspeaker which forms part of the communication device, are switched off. Communication which is free of interference and cannot be monitored is thus ensured.

Preferably, the multi-function interface is in such a form that a rechargeable battery which supplies the communication device with energy is charged by the multi-function interface. This makes further connections of the communication device unnecessary, and thus reduces production costs.

The transmission facility transmits the encrypted information, preferably via an unencrypted transmission path, to a first communication instrument. The first communication instrument preferably transmits it via an unencrypted transmission path to a second communication instrument, which transmits it via an unencrypted transmission path to a second transmission facility of a second communication device. In this way, secure communication of the encrypted information from the sender to the receiver, which are both communication devices according to the invention, using only unencrypted transmission paths, is given.

The communication instruments are preferably mobile telephones and/or fixed network telephones and/or computers. This allows high flexibility of information transmission.

Preferably, the unencrypted transmission paths between the communication devices and the communication instruments and between the communication instruments are unencrypted speech channels and/or unencrypted data channels. Transmission of any encrypted information via multiple possible unencrypted transmission paths is thus possible.

The unencrypted transmission paths between the communication devices and the communication instruments and between the communication instruments may be line-carried and/or not line-carried. Preferably, the connections are via serial cables and/or Bluetooth connections. Use of multiple communication instruments is thus possible.

Preferably, a communication connection from the communication device to the first communication instrument is maintained even if no information is transmitted. This gives permanent readiness for communication. Furthermore, in this way it is possible to react to incoming calls.

The communication device preferably can receive incoming audio calls and/or data calls. An incoming audio call and/or data call is preferably indicated by means of a signal loudspeaker and/or a vibrator. Thus a convenient signalling type, adapted to the user situation, can be used.

The communication device preferably has a display facility and a multi-function key, by means of which the communication device is controlled. Advantageously, control is via a menu structure on the display facility. Convenient, reliable control of the communication device is thus ensured.

Preferably, the communication device has a volume setting facility, which sets the volume of reproduction through the loudspeaker(s). A convenient volume for the individual user is thus ensured.

The communication device preferably has an eyelet, to which a chain or string, on which the communication device is preferably carried or fixed, can be fixed. Secure carrying of the communication device is thus ensured.

The communication device preferably has a clasp, by means of which the communication device is fixed on flat objects by clamps. Simple fixing on the user's belt or on a pocket of the clothing is thus possible.

The communication device preferably has a housing, which comprises at least two housing parts. Preferably, the housing parts are fixed to each other by the clasp. Additional stability of the housing is thus produced.

### BRIEF DESCRIPTION OF THE DRAWINGS

Below, the invention is described using an example, on the basis of the drawings, in which an advantageous embodiment of the invention is shown. In the drawings:

FIG. 1 shows the mechanical structure of an embodiment of a device according to the invention, in three views;

FIG. 2 shows a block diagram of an embodiment of a device according to the invention;

FIG. 3 shows a schematic representation of a first connection option of an embodiment of a device according to the invention;

FIG. 4 shows a schematic representation of a second connection option of an embodiment of a device according to the invention, and

FIG. 5 shows a schematic representation of a third connection option of an embodiment of a device according to the invention.

### DETAILED DESCRIPTION

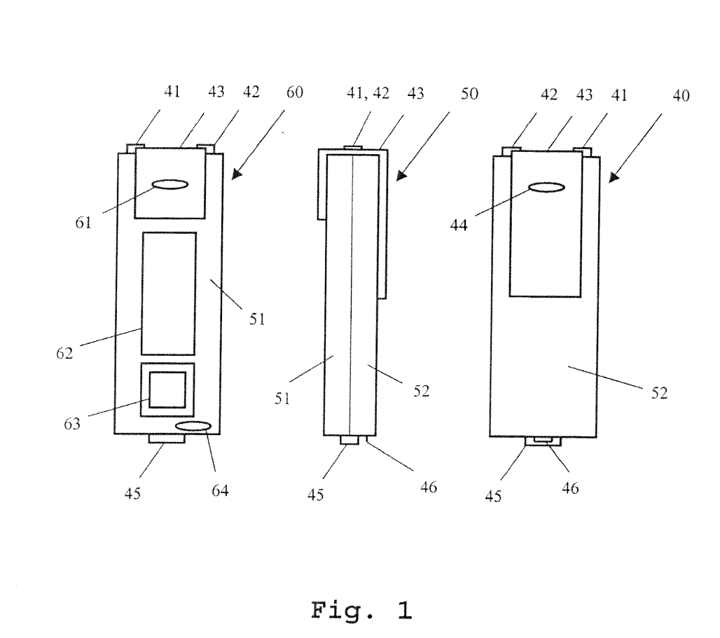

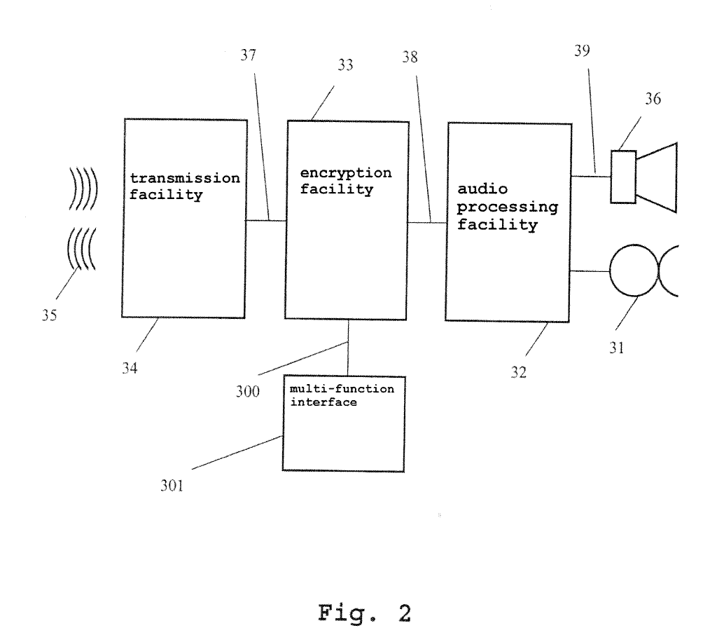

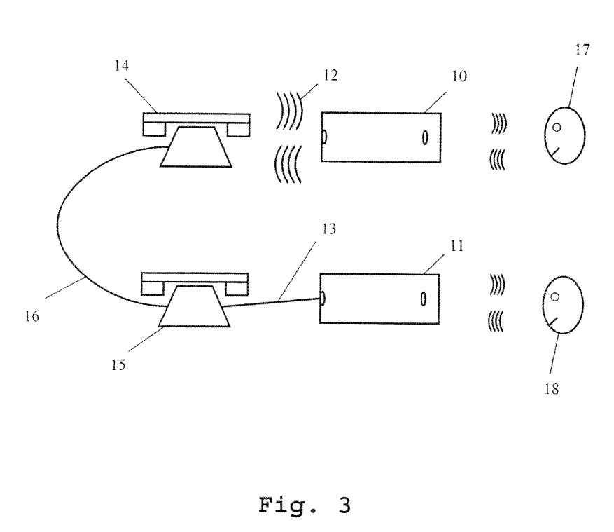

First, on the basis of FIGS. 1-2, the mechanical structure and functioning of the device according to the invention are explained. Various connection options and associated communication scenarios are illustrated by FIGS. 3-5. In some cases, identical elements in similar figures are not shown or described again.

In FIG. 1, the mechanical structure of an embodiment of the communication device according to the invention is shown in three views. On the front 60 of the communication device, a loudspeaker 61 for speech and sound reproduction is mounted. Also, a multi-function key 63 and a display 62 are attached. On the lower front, a microphone 64 is mounted. Also on the lower front, a multi-function interface 45 is attached. On the upper front, keys 41, 42 for setting the volume are mounted.

On the back 40 of the communication device, another loudspeaker 44 is mounted. On the lower front, next to the microphone 45, an eyelet 46 is attached.

In the side view 50 of the communication device, a clasp 43, which joins the housing front 51 and housing back 52, can clearly be seen. The clasp 43 has openings which enable the sound of the two loudspeakers 61 and 44 to pass through without hindrance.

By the multi-function interface 45, both instruments for input/output of data, e.g. a headset, computer or fax machine, and a battery charger can be connected. The multi-function interface 45 can also be used to connect the communication device to a communication instrument, which passes on the data. The functions of the communication device are controlled by means of the multi-function key 63 and display 62, via a menu structure. By the loudspeaker 61 and microphone 64, an encrypted audio connection can be set up. The reproduction volume can be set by means of the keys 41 and 42. Incoming calls are signalled by the loudspeaker 44. This loudspeaker 44 can also be used for hands-free operation. The clamp 43 fixes the housing parts 51, 52, and is simultaneously used to fix the communication device to, for instance, a belt or shirt pocket. On the eyelet 46, a chain or string, which is used for carrying the communication device, can be fixed.

FIG. 2 shows a block diagram of an embodiment of a communication device according to the invention. The communication device has a transmission facility 34, an encryption facility 33, an audio processing facility 32, a multi-function interface 301, at least one loudspeaker 36 and a microphone 31. The loudspeaker 36 and microphone 31 are connected to the audio processing facility 32. The audio processing facility 32 stands is in contact via a bidirectional communication connection 38 with the encryption facility 33. The encryption facility 33 is connected via a bidirectional communication connection to the transmission facility 34. The encryption facility 33 is also connected via a bidirectional communication connection 300 to the multi-function interface 301. Audio signals 302 which the microphone 31 receives are transmitted to the audio processing facility 32. The audio processing facility 32 processes the audio signals 302. This includes digitizing and filtering the audio signals 302. The audio processing facility 32 passes on the audio data via the bidirectional communication connection 38 to the encryption facility 33. The encryption facility 33 encrypts the audio data. The encrypted audio data are transmitted via the bidirectional communication connection 37 to the transmission facility 34. The transmission facility 34 transmits the encrypted audio data via a wireless interface 35. Alternatively, the encryption facility 33 transmits the encrypted audio data the bidirectional communication connection 300 to the multi-function interface 301. The multi-function interface 301 transmits the encrypted audio data via a lined-carried interface. If an audio call is not to be set up, but a data call, the data source/sink is connected via a line-carried interface to the multi-function interface 301.

The data are transmitted unencrypted via the bidirectional communication connection 300 to the encryption facility 33. The encryption facility 33 encrypts the data, and transmits it via the bidirectional communication facility 37 to the transmission facility 34. The transmission facility 34 transmits the encrypted data via a wireless interface 35. Alternatively, the data source/sink can be connected via the wireless interface 35 to the transmission facility 34. The unencrypted data are transmitted via the bidirectional communication connection 37 to the encryption facility 33. The encryption facility 33 encrypts the data, and transmits it via the bidirectional communication connection 300 to the multi-function interface 301. The multi-function interface 301 transmits the encrypted data via a line-carried interface.

In FIG. 3, a schematic representation of a first connection option of an embodiment of a communication device according to the invention is shown. The first communication device 10 is connected via the wireless interface 12 to a fixed network telephone 14. The wireless interface is a Bluetooth interface. The fixed network telephone 14 is connected via a line-carried interface 16 to a second fixed network telephone 15. The line-carried interface 16 is either a direct connection or a connection via a telecommunication network. The second fixed network telephone 15 is connected via a line-carried interface 13 to a second communication device 11. The line-carried interface 13 is a serial cable, which is connected to the multi-function interface 45 of the second communication device 11.

A user 17 sets up an audio call. The audio data are encrypted by the communication device 10. The encrypted audio data are transmitted via the unencrypted wireless interface 12, here a Bluetooth connection, to the first fixed network telephone 14, and from it via the unencrypted line-carried interface 16, here a telecommunication network, to the second fixed network telephone 15. From there, the data are is transmitted via the unencrypted line-carried interface 13 to the second communication device 11. There the data are decrypted and made available to the second user 18. Audio data which the second user 18 generates are transmitted on the same path in reverse sequence to the first user 17.

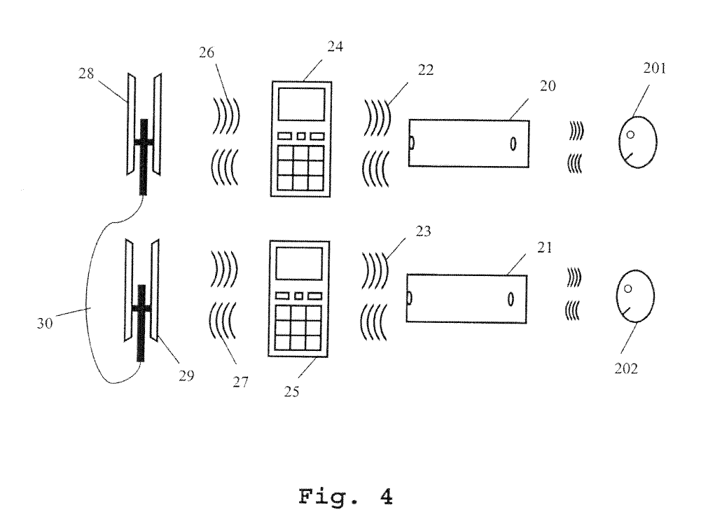

FIG. 4 shows a schematic representation of a second connection option of an embodiment of a communication device according to the invention. The first communication device 20 is connected via the wireless interface 22, here a Bluetooth connection, to a first mobile telephone 24. The first mobile telephone 24 is connected via the wireless interface 26, here a GSM connection, to a first base station 28. The first base station 28 is connected via a line-carried interface 30, which here is a telecommunication network, to a second base station 29. The second base station 29 is connected via the wireless interface 27, here a GSM connection, to a second mobile telephone 25. The second mobile telephone 25 is connected via the wireless interface 23, here a Bluetooth connection, to the second communication device 21.

A user 201 sets up an audio call. The audio data are encrypted by the communication device 20. The encrypted audio data are transmitted via the unencrypted wireless interface 22 to the first mobile telephone 24. The first mobile telephone 24 transmits the encrypted audio data via the unencrypted wireless interface 26 to the first base station 28. The latter transmits the encrypted audio data via the unencrypted wireless interface 27 to the second mobile telephone 25, which determines it via the unencrypted wireless interface 23 to the second communication device 21. The second communication device 21 decrypts the encrypted audio data and makes the data available to the second user 202. Audio data which the second user 202 generates are transmitted via the reverse path to the first user 201.

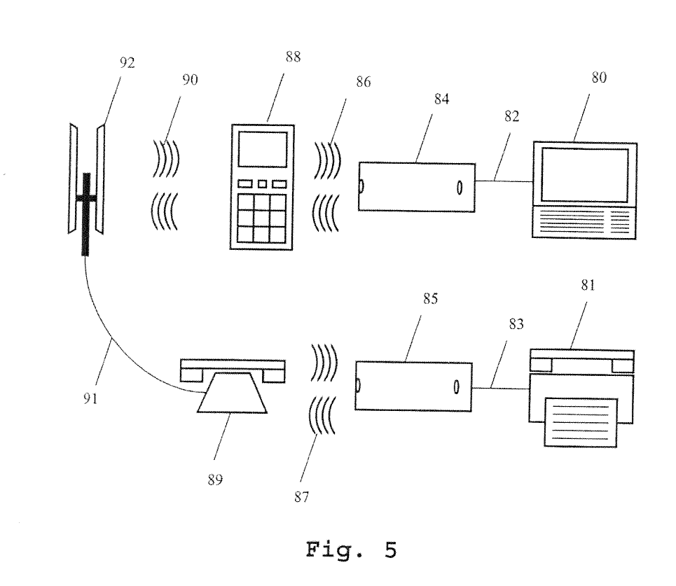

In FIG. 5, a schematic representation of a third connection option of an embodiment of a communication device according to the invention is shown. A computer 80 is connected via a line-carried interface 82, here a serial cable, to the multi-function interface of the first communication facility 84. The first communication facilities 84 is connected via the wireless interface 86, here a Bluetooth connection, to a first mobile telephone 88. The first mobile telephone 88 is connected via the wireless interface 90, here a UMTS connection, to a base station 92. The base station is connected via a line-carried interface 91 to a fixed network telephone 89. The line-carried interface 91 here is a telecommunication network. The fixed network telephone 89 is connected via a wireless interface 87, here a Bluetooth connection, to a second communication device 85. The second communication device 85 is connected via a line-carried interface 83 to a fax machine 81. A user initiates sending a fax. The fax machine 81 transmits unencrypted data via the line-carried interface 83 to the first communication device 85. The latter encrypts the data and transmits the data via the unencrypted wireless interface 87 to the fixed network telephone 89. The latter transmits the encrypted data via the unencrypted line-carried interface 91 to the base station 92, which sends the encrypted data via the unencrypted wireless interface 90 to the mobile telephone 88. The mobile telephone 88 transmits the encrypted data via the unencrypted wireless interface 86 to the first communication device 84, which decrypts the data and transmits the data via the line-carried interface 82 to the computer 80.

The invention is not restricted to the illustrated embodiment. As previously mentioned, different data formats and connection types can be transmitted in encrypted form. Use of a very wide variety of terminals, which are connected to the communication devices, is also conceivable. Replacement of a communication facility according to the invention on one side of the communication with software operated by a computer is also conceivable. All features described above or features shown in the figures can be arbitrarily combined with each other within the invention.

1-27. (canceled)

28. Communication device for encrypted transmission of information via unencrypted transmission paths, with at least one loudspeaker, one microphone, one audio processing facility, one encryption facility and one transmission facility, wherein
information is encrypted by the encryption facility, and
the encrypted information is transmitted via unencrypted transmission paths by the transmission facility by further communication instruments.

29. Communication device according to claim 28,
wherein the information comprises at least one of audio calls and data calls.

30. Communication device according to claim 29,
wherein the communication device sets up audio calls to a user by the audio processing facility, the loudspeaker, and the microphone.

31. Communication device according to claim 28,
wherein the communication device sets up data calls by a multi-function interface to at least one of a data source and a data sink.

32. Communication device according to claim 31,
wherein the data source and/or data sink is a computer or a mobile telephone.

33. Communication device according to claim 31,
wherein the data call between the multi-function interface and the data source and/or the data sink is unencrypted.

34. Communication device according to claim 31,
wherein the encryption facility encrypts and/or decrypts the information which is received and to be sent via the multi-function interface, and
the transmission facility transmits the encrypted information.

35. Communication device according to claim 31,
wherein the multi-function interface is in such a form that a microphone and/or headphones can be connected, and
when at least one of a microphone and headphones is or are connected, a microphone integrated into the communication device and/or a loudspeaker integrated into the communication device is or are switched off.

36. Communication device according to claim 31,
wherein the multi-function interface is in such a form that a rechargeable battery which supplies the communication device with energy is charged by the multi-function interface.

37. Communication device according to claim 28,
wherein the transmission facility transmits the encrypted information via an unencrypted transmission path to a first communication instrument,
the first communication instrument transmits the encrypted information via an unencrypted transmission path to a second communication instrument, and
the second communication instrument transmits the encrypted information via an unencrypted transmission path to a second transmission facility of a second communication device.

38. Communication device according to claim 37,
wherein at least one of the first communication instrument and the second communication instrument is a mobile telephone.

39. Communication device according to claim 37,
wherein at least one of the first communication instrument and the second communication instrument is a fixed network telephone.

40. Communication device according to claim 37,
wherein at least one of the first communication instrument and the second communication instrument is a computer.

41. Communication device according to claim 31,
wherein the unencrypted transmission paths between at least one of (a) the communication device and the first communication instrument, (b) the communication instruments, and (c) the second communication instrument and the second communication device, are unencrypted speech channels.

42. Communication device according to claim 31,
wherein the unencrypted transmission paths between at least one of (a) the communication device and the first communication instrument, (b) the communication instruments, and (c) the second communication instrument and the second communication device, are unencrypted data channels.

43. Communication device according to claim 31,
wherein the unencrypted transmission paths between at least one of (a) the communication device and the first communication instrument, (b) the communication instruments, and (c) the second communication instrument and the second communication device, are line-carried.

44. Communication device according to claim 43,
wherein the unencrypted transmission paths between at least one of (a) the communication device and the first communication instrument, (b) the communication instruments, and (c) the second communication instrument and the second communication device, are connections via serial cables.

45. Communication device according to claim 31,
wherein the unencrypted transmission paths between at least one of (a) the communication device and the first communication instrument, (b) the communication instruments, and (c) the second communication instrument and the second communication device, are not line-carried.

46. Communication device according to claim 45,
wherein the unencrypted transmission paths between (a) the communication device and the first communication instrument, (b) the communication instruments, and (c) the second communication instrument and the second communication device, are Bluetooth connections.

47. Communication device according to claim 31,
wherein the communication device is in such a form that a communication connection to the first communication instrument is maintained if no information is transmitted.

48. Communication device according to claim 28,
wherein
the communication device can receive incoming audio calls and/or data calls,
the communication device has at least one of a signal loudspeaker and a vibrator for indication, and
the communication device indicates incoming audio calls and/or data calls by the signal loudspeaker and/or vibrator.

49. Communication device according to claim 28,
wherein
the communication device has a display facility and a multi-function key, and
the communication device is controlled by the display facility and multi-function key.

50. Communication device according to claim 49,
wherein the multi-function key controls the communication device via a menu structure on the display facility.

51. Communication device according to claim 21,
wherein
the communication device has at least one loudspeaker,
the communication device has a volume setting facility, and
the volume setting facility sets the volume of reproduction through the loudspeaker(s).

52. Communication device according to claim 28,
wherein
the communication device has an eyelet, and
the communication device is carried or fixed by means of a chain or string which is fixed to the eyelet.

53. Communication device according to claim 28,
wherein
the communication device has a clasp, and
the clasp fixes the communication device on flat objects by clamps.

54. Communication device according to claim 53,
wherein
the communication device has a housing having at least
two housing parts fixed to each other by the clasp.
